(19) United States
(12) Patent Application Publication
(10) Pub. No.: US 2018/0200778 A1
(43) Pub. Date: Jul. 19, 2018

(54) APPARATUS FOR STACKING AND ALIGNING LAMINAR MEMBERS BLANKED RESPECTIVELY AND TRANSPORTING THE STACKED AND ALIGNED LAMINAR MEMBERS TO CONVEYOR

(71) Applicant: Jin Ju, Hwaseong-si (KR)

(72) Inventors: Jin Ju, Hwaseong-si (KR); Keun Sik Kim, Hwaseong-si (KR)

(21) Appl. No.: 15/865,256

(22) Filed: Jan. 9, 2018

(30) Foreign Application Priority Data
Jan. 17, 2017 (KR) 10-2017-0008344

(51) Int. Cl. B21D 43/22; B30B 15/32; B65H 29/26; B65H 29/50; B65H 31/10; B65H 31/34

(52) U.S. Cl. CPC B21D 43/22; B30B 15/32; B65H 29/26; B65H 29/50; B65H 2601/272; B65H 31/34; B65H 2801/42; B65H 2701/173; B65H 31/10

(57) ABSTRACT

An apparatus according to the present disclosure stacks and aligns predetermined number of laminar members blanked respectively by a blanking block and transports them to a conveyor, thereby eliminating the need for the conventional counting operation and alignment operation of laminar members, and efficiently performing a subsequent adhesion or welding process etc. of laminar members.

### TECHNICAL FIELD

The present disclosure relates to a an apparatus for stacking, aligning and transporting laminar members, and more particularly, to an apparatus that stacks and aligns predetermined number of laminar members blanked respectively by a blanking block and transports them to a conveyor.

The present application claims priority to Korean Patent Application No. 10-2017-0008344 (titled ‘Apparatus for stacking and aligning laminar members blanked respectively and transporting the stacked and aligned laminar members to conveyor), the disclosure of which is incorporated herein by reference.

### BACKGROUND ART

In general, a stack core made by stacking laminar members is used for a rotator and a stator in a power generator or a motor, and a method for manufacturing the same is well known in the art.

The stack core is manufactured by a stack core manufacturing apparatus, and Korean Patent Nos. 10-0578043, 10-0762744 and 10-1089903 disclose the manufacturing apparatuses and methods.

FIGS. 1a and 1b are plane view showing a rotor and a stator (hereinafter referred to as a laminar member) respectively, and FIG. 2 is a diagram showing a blanking unit 10 for making laminar member 1 by blanking a metal strip, and a conveyor 16 for transporting the laminar members outward.

The blanking unit 10 includes a blanking block 12 installed in a press 11, and a die 14 installed in a lower mold.

When the blanking block 12 makes up-and-down reciprocating movements with respect to the die 14, a metal strip 3 is blanked into laminar member 1, and the resulting laminar members are pushed into a blanking space(S), and drop down onto an underlying conveyor belt 16 one after another.

The conveyor belt 16 transports the laminar members placed thereon by motor (not shown). Therefore, the conveyor belt 16 transports the laminar members such that the laminar members are not in ordered stack state, and some of which are overlapped each other in disordered state.

Accordingly, for a subsequent adhesion or welding operation of the laminar members, an operation for counting the laminar members each predetermined number and an operation for aligning the counted laminar members are required, and it consumes large amount of time and labor to perform the counting operation and alignment operation of the laminar members. Specifically describing, to manufacture a rotator or a stator using the laminar members, it is necessary to align and stack each predetermined number of laminar members, and it consumes large amounts of time and efforts to count and align each predetermined number of laminar members, some of which are transported in disordered overlap state. Particularly, in case that the laminar member has a plurality of slots therein, it is necessary to match the slots when aligning the laminar members, and this operation needs large amounts of time and labor.

In addition, because the laminar member 1 are thin with the thickness of about 0.1 mm˜1 mm, the laminar member 1 may be damaged or bend during the alignment operation.

### SUMMARY OF THE DISCLOSURE

The present disclosure is designed to solve the above-mentioned problems, and therefore the present disclosure is directed to providing an apparatus that stacks and aligns each predetermined number of laminar members blanked respectively and transports the same.

The present disclosure is further directed to providing an apparatus that eliminates a counting operation and an alignment operation of the laminar members performed conventionally for a welding or adhesion operation of the laminar members.

To achieve the object, an apparatus 100 according to a preferred embodiment of the present disclosure includes a holder 110 installed on a circumference of blanking space(s) to support blanked laminar members, a movement means to move the holder 110 forward and rearward with respect to a center of the blanking space(s), and a vertical lift cylinder 140 which is installed moveably up and down below the holder 110, and has a load block 142 horizontally installed on top to load the laminar members, wherein the vertical lift cylinder 140 moves down when the laminar members having dropped down by rearward movement of the holder 110 are loaded on the load block 142, and moves up when the laminar members loaded on the load block 142 are removed from the load block 142.

A support section 112 is protrusively formed at a front end of the holder 110 to support a circumference of the laminar member.

An apparatus 200, 300 according to another preferred embodiment of the present disclosure includes a holder 110 installed on a circumference of blanking space(s) to support blanked laminar members, a movement means to move the holder 110 forward and rearward with respect to a center of the blanking space(s), and a vertical lift cylinder 240 which is installed moveably up and down below the holder 110 and has at least three piston rods 242 which simultaneously move up and down, wherein the vertical lift cylinder 240 moves down when the laminar members are loaded on top of the piston rods 242 by rearward movement of the holder 110, and moves up when the laminar members loaded on the piston rods 242 are removed from the piston rods 242.

The conveyor 260 includes a plurality of belts 262 spaced apart at a predetermined interval.

The piston rods 242 are inserted and installed moveably up and down between the belts spaced apart. Additionally, when the piston rods 242 move down below the belts 262, the laminar members are loaded on the belts 262.

Two or more holders 110 may be installed at a predetermined angle with respect to the center of the blanking space(s). The movement means is installed at the rear of each holder 110.

Additionally, the movement means includes a cylinder 120 for rearward movement which is connected to a rear end of the holder 110 to move back the holder 110, and an elastic element 125 which is installed at the rear end of the holder 110 to apply elastic resilience to advance the holder 110 having moved back.

When a preset number of laminar members are stacked on the support section 112, the cylinder 120 for rearward movement operates (moves back) so that the laminar members drop down onto the load block 142 or the piston rods 242. Additionally, immediately after the laminar members are removed from the support section 112 or after the laminar members are removed from the support section 112 and then a predetermined number of blanking is additionally performed, the operation of the cylinder 120 for rearward movement may be stopped and the holder 110 may move forward by resilience of the elastic element 125 and return to an original position.

The holder 110 may be slidably installed at a circular groove 20 formed on a circumference of the blanking space(s). The circular groove 20 may have a stopper 119 installed in front of the holder 110. The stopper 119 prevents the holder 110 from advancing too much to prevent the laminar members from deforming.

The apparatus 100, 200, 300 may further include a cylinder 170 for horizontal movement. The cylinder 170 for horizontal movement is installed in a lateral direction of the vertical lift cylinder 140. When the laminar members are stacked on the load block 142, the vertical lift cylinder 140 moves down, and when the vertical lift cylinder 140 is moved down, the cylinder 170 for horizontal movement extends in a horizontal direction to move the laminar members stacked on the load block 142 to the conveyor 160.

An available space section 30 having a larger diameter than a diameter d1 of the laminar member 1 may be formed on the holder 110, and a pinch section 40 satisfying the following equation may be formed on the available space section 30:

$$3 \times {10}^{- 4} \leq \frac{d 1 - d 2}{d 1} \leq 1 \times {10}^{- 3} \qquad [ Equation ]$$

in the equation,

d1: the diameter of the laminar member 1.

d2: an inner diameter of the pinch section 40.

The pinch section 40 is where centers of the laminar members are spaced apart from each other, and accordingly the laminar member drop down from the pinch section 40 one after another.

The support section 112 is protrusively formed at a front end of the holder 110, and an upper surface of the support section 112 is preferably formed as a slope surface having an angle P of 30°˜60° with respect to a horizontal line.

Meanwhile, in case that a plurality of slots are concavely formed on the circumference of the laminar member, preferably a protrusion is protrusively formed in at least one of sidewall of the cylindrical barrel 50 and sidewall of the available space section 30. The insertion of the protrusion into the slot prevents the laminar member 1 from rotating.

The load block 142 may be rotated at a predetermined angle after a predetermined number of blanking is performed. This rotation may remove or reduce a thickness difference of a product.

Meanwhile, the apparatus 100 may have a sensor 145 installed in the load block 142 and the operation is as below. Specifically, when a predetermined number of the laminar members are stacked on the support section 112, the vertical lift cylinder 140 may move up and when the vertical lift cylinder 140 touches the support section 112, the sensor 145 may sense it and transmit the signal to a control unit and the control unit may slowly move down the vertical lift cylinder 140, and at the same time, the holder 110 may move back so that the laminar members supported by the support section 112 drop down onto the load block 142, subsequently, blanking may continue with the holder 110 kept in back-moved state, and while the laminar members are additionally loaded on the load block 142, the vertical lift cylinder 140 may continuously move down, and when the laminar members loaded on the load block 142 reach a preset number, the vertical lift cylinder 140 may stop moving down and the holder 110 may move forward so that the support section 112 supports the laminar members, and the cylinder 170 for horizontal movement may move forward to move the laminar members loaded on the load block 142 to the conveyor 160.

The present disclosure has the following effects:

First, the predetermined number of laminar member 1 blanked respectively are stacked, aligned and then transported, and accordingly a counting operation and an alignment operation of the laminar members conventionally performed after a blanking process may be eliminated, and an adhesion or welding operation of the laminar members may be efficiently performed.

Second, the holder 110 is moved forward to the original position by the elastic resilience of the elastic element 125, and the stopper 119 is installed to prevent the holder 110 from advancing too much and prevent the laminar member 1 from deforming.

Third, as the pinch section 40 is provided, the blanked laminar members are transported to the holder 110 one by one, and accordingly an accurate number of laminar members may be stacked.

Fourth, it is possible to prevent the blanked laminar member 1 from rotating during downward movement, and accordingly prevent the misalignment of the slots of the stacked laminar members.

Fifth, the minimum spacing between the support section 112 and the load block 142 may prevent or minimize the scattering of the laminar members while the laminar members drop down.

### BRIEF DESCRIPTION OF THE DRAWINGS

FIGS. 1a and 1b are photographic images showing a rotor and a stator respectively.

FIG. 2 is a cross-sectional view showing a structure in which blanked laminar members are transported according to the conventional art.

FIG. 3 is a cross-sectional view showing a transport apparatus according to a preferred embodiment of the present disclosure.

FIG. 4 is a plane view showing a holder and a movement means provided in the transport apparatus of FIG. 3.

FIG. 5 is an enlarged view of section A of FIG. 3.

FIGS. 6˜9 are diagrams sequentially showing an operation process of a transport apparatus.

FIG. 10 is a plane view showing a holder in open state (moved rearward) in FIG. 7.

FIG. 11 is an enlarged view of section B of FIG. 6.

FIG. 12 is an enlarged view of section C of FIG. 6.

FIG. 13 is a diagram showing a vertical lift cylinder with a sensor.

FIG. 14 is a diagram showing a vertical lift cylinder with an indexing unit and a sensor.

FIG. 15 is a cross-sectional view showing a transport apparatus with the vertical lift cylinder of FIG. 14.

FIG. 16 is a cross-sectional view showing a transport apparatus according to another preferred embodiment of the present disclosure.

FIG. 17 is a cross-sectional view showing a transport apparatus according to still another preferred embodiment of the present disclosure.

### DETAILED DESCRIPTION

Hereinafter, the present disclosure will be described in detail with reference to the accompanying drawings. Prior to the description, it should be understood that the terms or words used in the specification and the appended claims should not be construed as limited to general and dictionary meanings, but interpreted based on the meanings and concepts corresponding to the technical spirit of the present disclosure on the basis of the principle that the inventor is allowed to define the concept of terms appropriately for the best explanation. Therefore, the embodiments stated herein and the illustration depicted in the drawings are just embodiments of the present disclosure and do not fully represent the technical spirit of the present disclosure, so it should be understood that other equivalents and modifications could be made thereto at the time of filing the application.

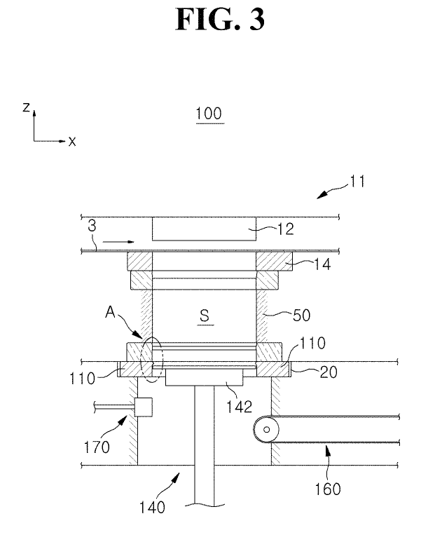

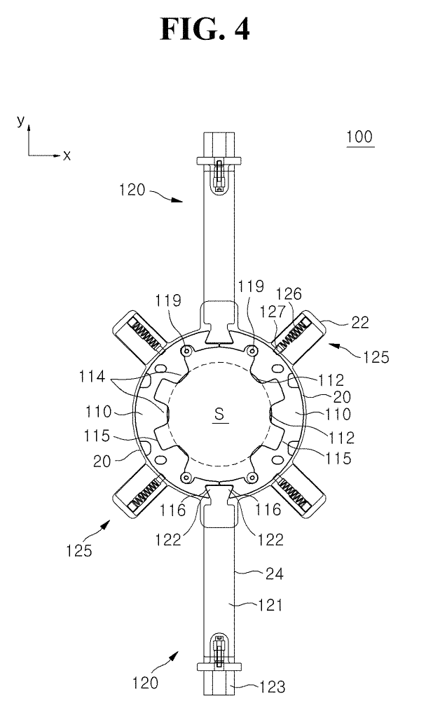

FIG. 3 is a cross-sectional view showing a transport apparatus according to a preferred embodiment of the present disclosure, and FIG. 4 is a plane view showing a holder and a movement means provided in the transport apparatus.

As shown in the drawings, the transport apparatus 100 includes a holder 110, a movement means to move the holder 110 forward and rearward, and a vertical lift cylinder 140. The transport apparatus 100 stacks the laminar member 1 made by blanking a metal strip 3 by a blanking block 12 and a die 14 such that each predetermined number of laminar members are aligned, and transports the same to a conveyor 160.

The blanking block 12 is installed in a press 11 and makes up-and-down reciprocating movements together with the press 11 to blank the metal strip 3 to manufacture the laminar member 1. Additionally, as blanking proceeds, the laminar member 1 is pushed down. A blanking process of the metal strip 3 by the blanking block 12 and the die 14 is well known in the art, and its detailed description is omitted herein.

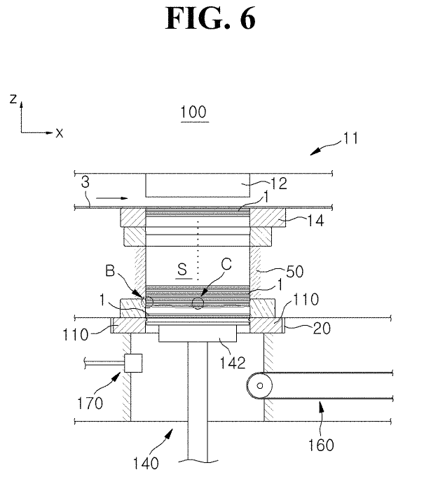

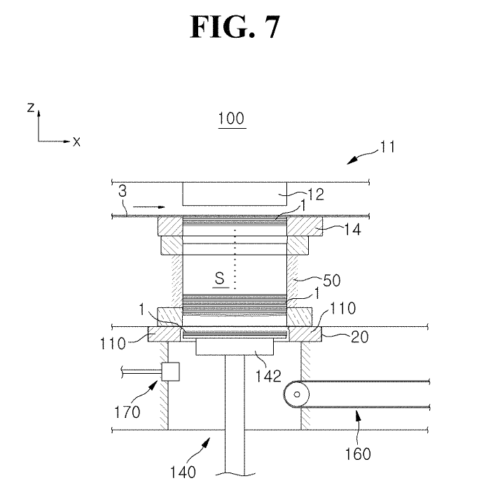

A cylindrical space is formed below the die 14 by a cylindrical barrel 50, a pinch section 40, an available space section 30 and the holder 110, and in the specification, this space is referred to as ‘blanking space(s)’ for convenience. Additionally, in FIGS. 6˜9, the points within the cylindrical barrel 50 indicate the laminar members. That is, for convenience of understanding, some of the laminar members in the cylindrical barrel 50 of FIGS. 6˜9 are indicated by a dotted line. Accordingly, when a blanking process is performed, the inner part of the cylindrical barrel 50 is packed with the laminar members, and the blanked laminar members are pushed down from top in a sequential order.

The holder 110 is slidably installed in a circular groove 20. The circular groove 20 is formed at the circumference of the blanking space(s). Additionally, grooves 22 for installing elastic elements 125 are formed at 90° interval and grooves 24 for installing cylinders 120 for rearward movement are formed at 180° interval, along the circumference of the circular groove 20.

Although the drawing shows two holders 110 installed at 180° interval, three or more holders 110 may be installed depending on the necessity. When the number of holders 110 is three, the holders 110 may be arranged at 120° interval, and when the number of holders 110 is four, the holders 110 may be arranged at 90° interval. Additionally, the cylinder 120 for rearward movement and the elastic element 125 are installed at the rear end of each holder 110.

The holder 110 may have protrusions 114 and recesses 115 in a repeatedly alternating manner on the inner side surface. Support sections 112 may be formed at the front end of the protrusions 114, and stoppers 119 may be installed in at least two of the recesses 115.

The stopper 119 is installed perpendicularly to the circular groove 20 and prevents the holder 110 from advancing too much to prevent the laminar members from deforming. That is, in case that the holder 110 having moved back by the cylinder 120 advances by the resilience of the elastic element 125, when the holder 110 advances too much or the cylinder 120 for rearward movement malfunctions, the laminar members may be deformed by an excessive force, and the stopper 119 prevents the holder 110 from advancing too much to prevent the laminar members from deforming.

The holder 110 has a groove 116 for coupling with a connecting bar 121 at two ends. The two sides at the front end of the connecting bar 121 are formed in a shape that matches the groove 116, and when the two sides at the front end are inserted into the groove 116, the holder 110 and the connecting bar 121 are coupled. As one connecting bar 121 is inserted into the grooves 116 of two holder 110, when the connecting bar 121 moves forward and rearward, the two holders 110 on the two sides simultaneously move forward and rearward.

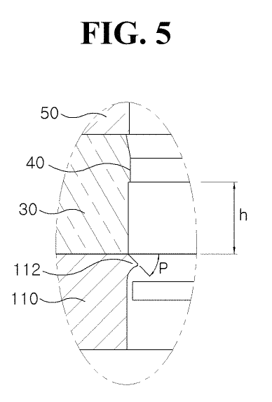

The support section 112 protrudes from the front end of the holder 110. As shown in FIG. 5, the upper surface of the support section 112 is formed as a slope surface having an angle P (30°˜60°) with respect to the horizontal line.

The movement means includes the cylinder 120 for rearward movement and the elastic element 125.

The cylinder 120 for rearward movement is installed at the groove 24. The cylinder 120 for rearward movement includes a cylinder body 123 and the connecting bar 121. The operation of the cylinder 120 for rearward movement may work with the operation of the press 11. For example, each time blanking is performed 10 times, the cylinder 120 for rearward movement may operate to move back the holder 110. Alternatively, after blanking is performed 5 times, the cylinder 120 for rearward movement may operate so that the holder 110 is opened (move rearward), subsequently, this open state is maintained until blanking is additionally performed 15 times, and then the operation of the cylinder 120 for rearward movement may stop so that the holder 110 is closed (move forward), and in this case, after a total of 20 laminar members are loaded and aligned on a load block 142, they are moved to the conveyor 160.

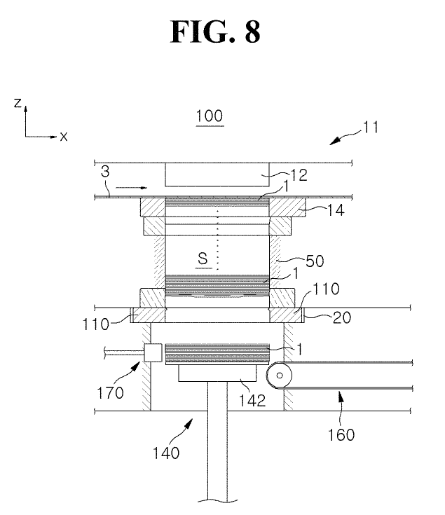

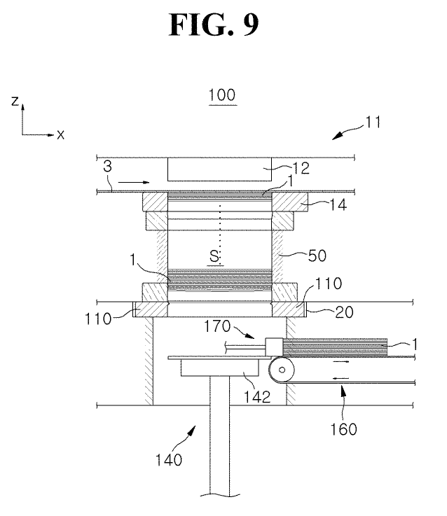

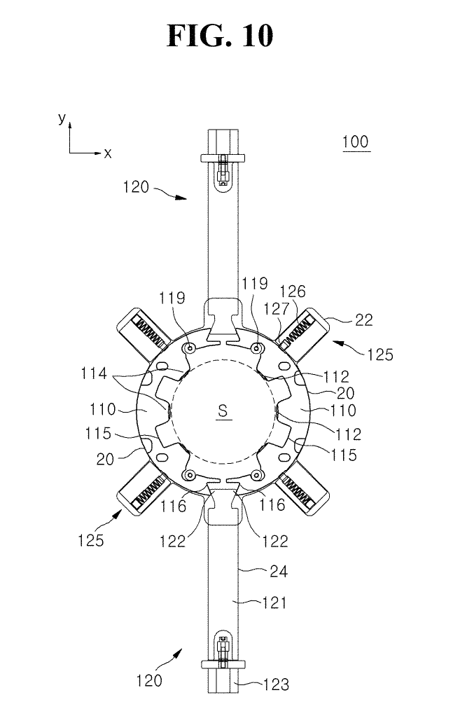

FIGS. 3, 4 and 6 show that the cylinder 120 for rearward movement is in non-operation, i.e., the holder 110 moves forward, and when the holder 110 moves forward, the blanked laminar member 1 are stuck with the support section 112. Meanwhile, FIGS. 7 and 10 show that as the cylinder 120 for rearward movement operates, the holder 110 moves rearward. When the holder 110 moves rearward, the laminar members stacked on the support section 112 drop down onto the load block 142. FIG. 6 shows that the laminar members are stacked on the support section 112, and FIG. 7 shows that as the holder 110 moves rearward, the laminar members stacked on the support section 112 drop down onto the load block 142.

Immediately after the laminar members stacked on the support section 112 drop down onto the load block 142, or after the laminar members drop down onto the load block 142, followed by a predetermined number of additional blanking, the operation of the cylinder 120 for rearward movement stops and the holder 110 moves forward by the elastic resilience of the elastic element 125, and when the holder 110 moves forward, the blanked laminar members are stacked on the support section 112.

As described above, the elastic element 125 provides elastic resilience to return the holder 110 having moved rearward to the original position. Only one elastic element 125 may be installed for each holder 110, but for stable operation, two or more elastic elements 125 are preferably installed for each holder 110.

The elastic element 125 includes a body, a spring 126 installed within the body, and a press rod 127 slidably installed at the body.

The press rod 127 receives the elastic resilience of the spring 126 and applies a force to move the holder 110 forward.

Meanwhile, the pinch section 40 and the available space section 30 are preferably provided on the holder 110.

The pinch section 40 is provided below the cylindrical barrel 50, and an inner diameter d2 of the pinch section 40 satisfies the following equation with a diameter d1 of the laminar members 1.

$$3 \times {10}^{- 4} \leq \frac{d 1 - d 2}{d 1} \leq 1 \times {10}^{- 3} \qquad [ Equation 1 ]$$

In the above equation,

d1: the diameter of the laminar member 1.

d2: the inner diameter of the pinch section 40.

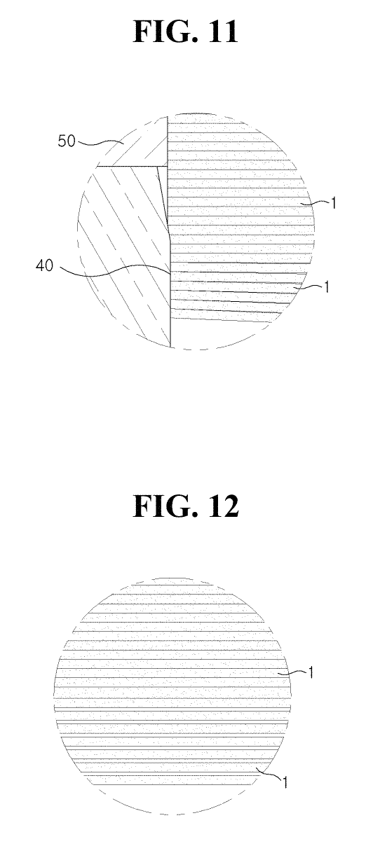

Because the inner diameter d2 of the pinch section 40 is slightly smaller than the diameter d1 of the laminar members, the centers of the laminar members entering the pinch section 40 are spaced apart from each other. That is, as shown in FIGS. 11˜12, the laminar member 1 entering the pinch section 40 is deformed a little bit convexly downward, and due to this deformation, the center of the laminar member 1 is spaced apart from each other, and due to this spacing, the laminar members are not adhered to each other, and accordingly, the laminar member 1 drop down onto the support section 112 one by one. If the pinch section 40 is absent, the laminar members may be stained with punching oil and thus adhered with low adhesive strength, and accordingly two or more laminar members may drop down at one time. Meanwhile, in FIGS. 11˜12, to distinguish the gap between the laminar members, the laminar members are designated by hatching.

In the above equation 1, when (d1−d2)/d1 is smaller than 3×10⁻⁴, the spacing between the laminar members 1 is insufficient, and when (d1−d2)/d1 is greater than 1×10⁻³, it is undesirable because there is high likelihood that the laminar member 1 will deform.

The available space section 30 is provided between the pinch section 40 and the holder 110. The available space section 30 preferably has an inner diameter that is slightly larger than the diameter of the laminar member 1. The available space section 30 prevents the backflow of the laminar member 1 not transported down in the event that the holder 110 malfunctions.

Additionally, the height h of the available space section 30 is preferably about 10 mm˜15 mm. When the height h is less than 10 mm, there is no time enough to deal with malfunction of the holder 110 if any, and when the height h exceeds 15 mm, the laminar member 1 rotate during fall, making it difficult to align the laminar members.

Meanwhile, a plurality of slots may be concavely formed on the circumference of the laminar member according to the type of the laminar member. The laminar members with the slots are disclosed by Korean Patent Nos. 10-1089903 and 10-0976575.

The inner sidewall of the cylindrical barrel 50 and the inner sidewall of the available space section 30 may have protrusions (not shown) at the location corresponding to the slots. The protrusions are inserted into the slots to prevent the laminar member 1 from rotating while the laminar member 1 is moving downward.

The protrusions may be formed in either the inner sidewall of the cylindrical barrel 50 or the inner sidewall of the available space section 30, or both.

The vertical lift cylinder 140 is installed moveably up and down below the holder 110. The load block 142 is horizontally installed on top of the vertical lift cylinder 140.

The laminar members stacked on the support section 112 drop down by the rearward movement of the holder 110 and are loaded on the load block 142. Additionally, when the laminar members are stacked on the load block 142, the vertical lift cylinder 140 moves down, and after the downward movement, when the laminar members are removed from the load block 142, the vertical lift cylinder 140 moves up.

FIG. 7 shows that the holder 110 is opened, and the laminar members stacked on the support section 112 drop down onto the load block 142, and in this state, as shown in FIG. 8, the holder keeps open, and thus while the vertical lift cylinder 140 is slowly moving down, the blanked laminar members are loaded on the load block 142. Subsequently, when the vertical lift cylinder 140 moves down to a predetermined height, the downward movement stops, a cylinder 170 for horizontal movement operates to horizontally move the laminar members loaded on the load block 142 and load them on the conveyor 160. The laminar members loaded on the conveyor 160 moves to an adhesion process or welding process or a packing process. As described above, the transport apparatus 100 according to the present disclosure stacks, aligns and transports each predetermined number of individually blanked laminar members, thereby eliminating the need for a counting operation and an alignment operation of the laminar members performed by the conventional apparatus.

The foregoing describes that the holder 110 keeps open and the laminar members are continuously loaded on the load block 142 while the vertical lift cylinder 140 is moving down. However, the holder 110 can be closed (move forward) immediately after the holder 110 is opened and the laminar members stacked on the support section 112 are loaded on the load block 142, and in this case, the laminar members newly dropped from the pinch section 40 are stacked on the support section 112.

The cylinder 170 for horizontal movement is installed in the lateral direction of the vertical lift cylinder 140. As shown in FIGS. 8˜9, the cylinder 170 for horizontal movement moves the laminar members loaded on the load block 142 to the conveyor 160.

The operation of the vertical lift cylinder 140 and the cylinder 170 for horizontal movement may work with up-and-down movement (blanking) of the press 11. For example, after blanking is performed five times, the vertical lift cylinder 140 starts to move down upon 6th blanking, and the downward movement may stop immediately after 20th blanking. Additionally, upon 21st blanking, the cylinder 170 for horizontal movement starts to move the laminar members loaded on the load block 142 to the conveyor 160, and the vertical lift cylinder 140 completes the upward movement to the original position before 25th blanking. In this case, a total of 20 laminar members are loaded on the load block 142.

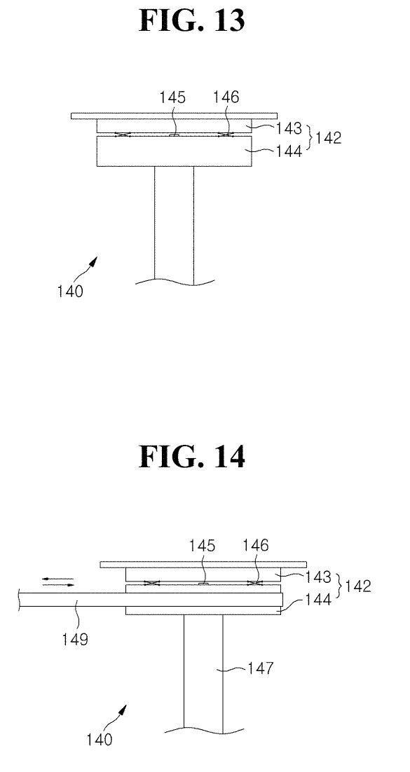

FIG. 13 shows that a sensor 145 is installed in the load block 142 of the vertical lift cylinder 140. The load block 142 includes an upper block 143 and a lower block 144, and the upper and lower blocks 143, 144 are spaced apart at a predetermined distance, and a spring 146 and the sensor 145 are installed at the gap.

When the vertical lift cylinder 140 moves up such that the top of the load block 142 touches the support section 112, the gap between the upper block 143 and the lower block 144 reduces, and when the sensor 145 senses this and transmits a signal to a control unit (not shown), the control unit moves the holder 110 rearward to allow the laminar members stacked on the support section 112 to drop down onto the load block 142 and moves down the vertical lift cylinder 140. Additionally, when the vertical lift cylinder 140 moves down, the gap is returned to the original gap by the elastic resilience of the spring 146. As described, the present invention prevents the laminar members from scattering by minimizing the falling distance between the load block 142 and the support section 112.

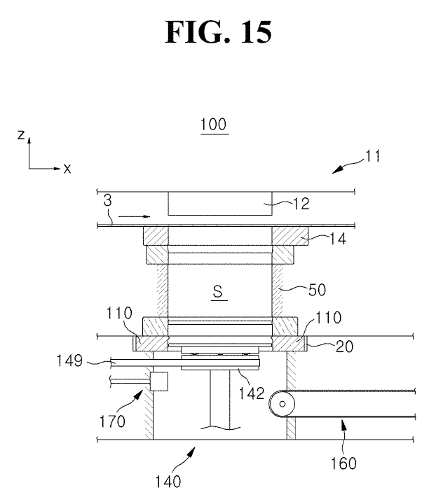

FIG. 14 is a diagram showing the vertical lift cylinder 140 with an indexing unit and the sensor 145, and FIG. 15 is a cross-sectional view showing the transport apparatus with the vertical lift cylinder of FIG. 14.

The metal strip 3 may have a non-uniform thickness. Accordingly, when a plurality of laminar members made by blanking are stacked, there may be a thickness difference between left and right sides. To solve this problem, the vertical lift cylinder 140 has the load block 142 rotatably installed at a piston rod 147. And, the load block 142 is rotated every predetermined number of blanking by the indexing unit. For example, the load block 142 may be rotated at a predetermined angle, for example, one of the angles 90°, 120° and 180° for every 20 blanking.

The indexing unit includes a belt 149 installed on the outer circumferential surface of the load block 142. The indexing unit operates with the up-and-down motion of the press, and the configuration is disclosed by Korean Patent Nos. 10-0976575 and 10-0578043, and those skilled in the art will easily understand the configuration of the indexing unit by referring to the specification.

Meanwhile, the indexing unit may be comprised with an electric motor (not shown). That is, each time the up-and-down motion of the press is made a predetermined number of times, the sensor (not shown) senses this and transmits a signal to the control unit (not shown), the control unit operates the electric motor to operate the belt 149 so that the load block 142 is rotated at a predetermined angle.

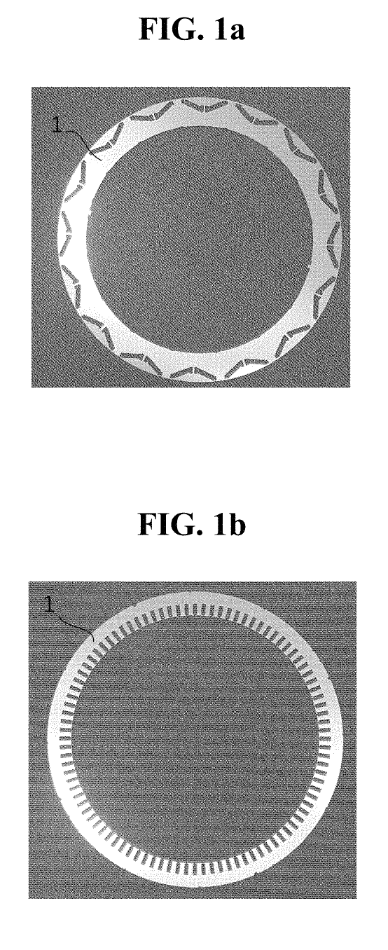

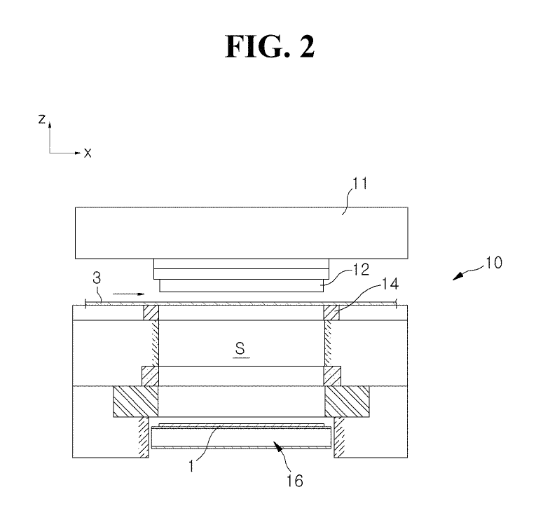

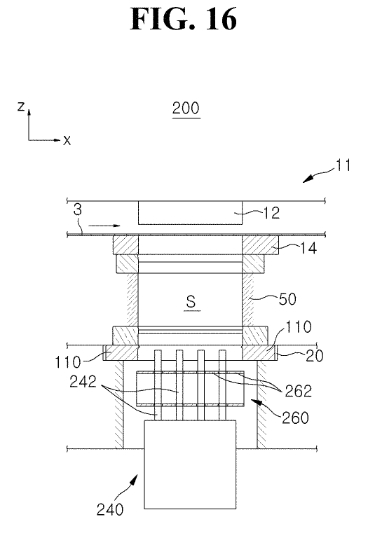

FIG. 16 is a cross-sectional view showing a transport apparatus according to another preferred embodiment of the present disclosure. The same reference numerals in FIG. 16 as those of FIGS. 1˜15 indicate the same elements.

As shown in the drawing, the transport apparatus 200 includes the holder 110, a movement means to move the holder 110 forward and rearward, a vertical lift cylinder 240 and a conveyor 260.

In comparison of the transport apparatus 200 with the transport apparatus 100, there is a difference in that the transport apparatus 200 has the conveyor 260 installed in y direction (a direction perpendicular to the drawing) and does not need the cylinder 170 for horizontal movement, and the vertical lift cylinder 240 does not have the load block 142.

The vertical lift cylinder 240 is installed below the conveyor 260, and three or more piston rods 242 simultaneously move up and down through the conveyor 260. The piston rods are arranged to support the laminar members loaded on top thereof. Accordingly, when the piston rods 242 move down, the laminar members loaded on top of the piston rods 242 are loaded on the conveyor belt 260. Additionally, when the loading is completed, the piston rods 242 move up to the original position.

The conveyor belt 260 includes a plurality of belts 262 spaced apart at a predetermined interval. The belts 262 are moved by a drive motor (not shown). The piston rods 242 are inserted and installed moveably up and down between the belts 262.

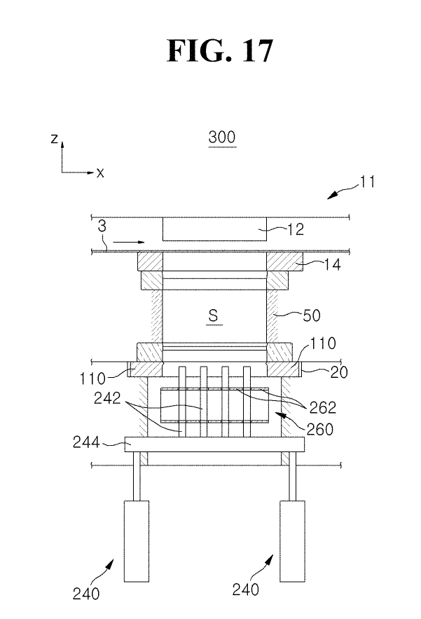

FIG. 17 is a cross-sectional view showing a transport apparatus according to still another preferred embodiment of the present disclosure. In the reference numerals of FIG. 17, the same reference numerals as those of FIGS. 1˜16 indicate the same elements.

As shown in the drawing, the transport apparatus 300 includes the holder 110, the movement means to move the holder 110 forward and rearward, the vertical lift cylinder 240, and the conveyor 260.

In comparison of the transport apparatus 300 with the transport apparatus 200, there is a difference in that the transport apparatus 300 includes the vertical lift cylinder 240 installed at two sides of the conveyor 260. That is, a connecting plate 244 is installed at the top of two vertical lift cylinders 240, and three or more piston rods 242 are installed on the connecting plate 244. When two vertical lift cylinders 240 move up and down, the three or more piston rods 242 move up and down at the same time accordingly.

When the piston rods 242 moves down, the laminar members loaded at the top of the piston rods 242 are loaded on the conveyor 260. Additionally, when the loading is completed, the piston rods 242 move up to the original position.

What is claimed is:

1. A transport apparatus for transporting laminar members made by blanking a metal strip (3) by a blanking block (12) installed in a press (11) such that each predetermined number of the laminar members are stacked and aligned, the transport apparatus comprising:
a holder (110) installed on a circumference of blanking space(s) to support the blanked laminar members;
a movement means to move the holder (110) forward and rearward with respect to a center of the blanking space(s); and
a vertical lift cylinder (140) which is installed moveably up and down below the holder (110), and has a load block (142) horizontally installed on top to load the laminar members, wherein the vertical lift cylinder (140) moves down when the laminar members having dropped down by rearward movement of the holder (110) are loaded on the load block (142), and moves up when the laminar members loaded on the load block (142) are removed from the load block (142),
wherein a support section (112) is protrusively formed at a front end of the holder (110) to support a circumference of the laminar member (1).

2. The transport apparatus according to claim 1, wherein two or more holders (110) are installed at a predetermined angle with respect to the center, and the movement means is installed at the rear of each holder (110),
the movement means comprises:
a cylinder (120) for rearward movement which is connected to a rear end of the holder (110) to move back the holder (110); and
an elastic element (125) which is installed at the rear end of the holder (110) to apply elastic resilience to advance the holder (110) having moved back,
when a preset number of laminar members are stacked on the support section (112), the cylinder (120) for rearward movement moves back so that the laminar members drop down onto the load block (142), and
immediately after the laminar members are removed from the support section (112) or after the laminar members are removed from the support section (112) and then a predetermined number of blanking is performed, the operation of the cylinder (120) for rearward movement is stopped and the holder (110) moves forward by resilience of the elastic element (125) and returns to an original position.

3. The transport apparatus according to claim 1, wherein the holder (110) is slidably installed in a circular groove (20) formed on a circumference of the blanking space(s), and the circular groove (20) has a stopper (119) installed in front of the holder (110),
the stopper (119) prevents the holder (110) from advancing too much to prevent the laminar members from deforming.

4. The transport apparatus according to claim 1, further comprises:
a cylinder (170) for horizontal movement installed in a lateral direction of the vertical lift cylinder (140),
wherein when the laminar members are stacked on the load block (142), the vertical lift cylinder (140) moves down, and then the cylinder (170) for horizontal movement extends in a horizontal direction to move the laminar members stacked on the load block (142) to the conveyor (160).

5. The transport apparatus according to claim 1, wherein an available space section (30) having a larger diameter than a diameter (d1) of the laminar member (1) is formed on the holder (110), and a pinch section (40) satisfying the following equation is formed on the available space section (30), and
the centers of the laminar members are spaced apart from each other in the pinch section (40), and accordingly the laminar members drop down from the pinch section (40) one by one:
$$3 \times {10}^{- 4} \leq \frac{d 1 - d 2}{d 1} \leq 1 \times {10}^{- 3} \qquad [ Equation ]$$
in the equation,
d1: the diameter of the laminar member (1).
d2: an inner diameter of the pinch section (40).

6. The transport apparatus according to claim 2, wherein the support section (112) is protrusively formed at a front end of the holder (110), and an upper surface of the support section (112) is formed as a slope surface having an angle (P) of 30°˜60° with respect to a horizontal line.

7. The transport apparatus according to claim 1, wherein a cylindrical barrel (50) serving as a passage through which the blanked laminar member (1) move down is installed below the die (14), an available space section (30) is installed below the cylindrical barrel (50), and a plurality of slots are concavely formed on the circumference of the laminar member (1),
a protrusion is protrusively formed in at least one of sidewall of the cylindrical barrel (50) and sidewall of the available space section (30), and is inserted into the slot, and
the insertion of the protrusion into the slot prevents the laminar member (1) from rotating.

8. The transport apparatus according to claim 1, further comprising:
an indexing unit which works with an up-and-down motion of the press (11),
wherein the load block (142) is rotatably installed at the piston rods of the vertical lift cylinder (140), and
the indexing unit rotates the load block (142) at a predetermined angle whenever each predetermined number of the laminar members are stacked on the load block (142).

9. The transport apparatus according to claim 1, wherein when a predetermined number of the laminar members are stacked on the support section (112), the vertical lift cylinder (140) moves up, and when the vertical lift cylinder (140) touches the support section (112), the holder (110) moves back so that the laminar members supported by the support section (112) drop down onto the load block (142), subsequently, blanking continues with the holder (110) kept in back-moved state, and while the laminar members are additionally loaded on the load block (142), the vertical lift cylinder (140) continuously moves down, and when the laminar members loaded on the load block (142) reach a preset number, the vertical lift cylinder (140) stops moving down and the holder (110) moves forward so that the support section (112) supports the laminar members, and the cylinder (170) for horizontal movement moves forward to move the laminar members loaded on the load block (142) to the conveyor (160).

10. A transport apparatus for transporting laminar members (1) made by blanking a metal strip (3) by a blanking block (12) installed in a press (11) such that each predetermined number of the laminar members are stacked and aligned, the transport apparatus comprising:
a holder (110) installed on a circumference of blanking space(s) to support the blanked laminar members;
a movement means to move the holder (110) forward and rearward with respect to a center of the blanking space(s); and
a vertical lift cylinder (240) which is installed moveably up and down below the holder (110) and has at least three piston rods (242) which simultaneously move up and down, wherein the vertical lift cylinder (240) moves down when the laminar members are loaded on top of the piston rods (242) by rearward movement of the holder (110), and move up when the laminar members loaded on the piston rods (242) are removed from the piston rods (242),
wherein the conveyor (260) includes a plurality of belts (262) spaced apart at a predetermined gap, the piston rods (242) are inserted and installed moveably up and down between the belts spaced apart, and when the piston rods (242) move down below the belts (262), the laminar members are loaded on the belts (262).

11. The transport apparatus according to claim 10, wherein two or more holders (110) are installed at a predetermined angle with respect to the center, and the movement means is installed at the rear of each holder (110),
the movement means comprises:
a cylinder (120) for rearward movement which is connected to a rear end of the holder (110) to move back the holder (110); and
an elastic element (125) which is installed at the rear end of the holder (110) to apply elastic resilience to advance the holder (110) having moved back,
when a preset number of laminar members are stacked on the support section (112), the cylinder (120) for rearward movement moves back so that the laminar members drop down onto the piston rods (242), and
immediately after the laminar members are removed from the support section (112) or after the laminar members are removed from the support section (112) and then a predetermined number of blanking is performed, the operation of the cylinder (120) for rearward movement is stopped and the holder (110) moves forward by resilience of the elastic element (125) and returns to an original position.

12. The transport apparatus according to claim 11, wherein the holder (110) is slidably installed in a circular groove (20) formed on a circumference of the blanking space(s), and the circular groove (20) has a stopper (119) installed in front of the holder (110),
the stopper (119) prevents the holder (110) from advancing too much to prevent the laminar members (1) from deforming.

13. The transport apparatus according to claim 10, wherein an available space section (30) having a larger diameter than a diameter (d1) of the laminar member (1) is formed on the holder (110), and a pinch section (40) satisfying the following equation is formed on the available space section (30), and
the centers of the laminar members are spaced apart from each other in the pinch section (40), and accordingly the laminar members drop down from the pinch section (40) one by one:
$$3 \times {10}^{- 4} \leq \frac{d 1 - d 2}{d 1} \leq 1 \times {10}^{- 3} \qquad [ Equation ]$$
in the equation,
d1: the diameter of the laminar members (1).
d2: an inner diameter of the pinch section (40).

14. The transport apparatus according to claim 11, wherein the support section (112) is protrusively formed at a front end of the holder (110), and an upper surface of the support section (112) is formed as a slope surface having an angle (P) of 30°˜60° with respect to a horizontal line.

15. The transport apparatus according to claim 10, wherein a cylindrical barrel (50) serving as a passage through which the blanked laminar members move down is installed below the die (14), an available space section (30) is installed below the cylindrical barrel (50), and a plurality of slots are concavely formed on the circumference of the laminar member (1),
a protrusion is protrusively formed in at least one of sidewall of the cylindrical barrel (50) and sidewall of the available space section (30), and is inserted into the slot, and
the insertion of the protrusion into the slot prevents the laminar member (1) from rotating.
